(19) United States
(12) Patent Application Publication
(10) Pub. No.: US 2025/0045495 A1
(43) Pub. Date: Feb. 6, 2025

(54) FIELD-BASED ADDITIVE MANUFACTURING DIGITAL MODEL FEATURE IDENTIFICATION AND EXTRACTION METHOD AND DEVICE

(71) Applicant: HUAZHONG UNIVERSITY OF SCIENCE AND TECHNOLOGY, Hubei (CN)

(72) Inventors: Lichao Zhang, Hubei (CN); Senlin Wang, Hubei (CN); Zihua Zhang, Hubei (CN); Jinxin Wu, Hubei (CN); Si Chen, Hubei (CN); Jiang Huang, Hubei (CN)

(73) Assignee: HUAZHONG UNIVERSITY OF SCIENCE AND TECHNOLOGY, Hubei (CN)

(21) Appl. No.: 18/735,168

(22) Filed: Jun. 5, 2024

(30) Foreign Application Priority Data
Aug. 1, 2023 (CN) 202310959914.X

(51) Int. Cl. G06F 30/27; B29C 64/386; B33Y 50/00; G06F 30/17; G06F 113/10

(52) U.S. Cl. CPC G06F 30/27; B29C 64/386; B33Y 50/00; G06F 30/17; G06F 2113/10

(57) ABSTRACT

The disclosure belongs to the technical field related to additive manufacturing model preprocessing, and discloses a field-based additive manufacturing digital model feature identification and extraction method and device, the method can convert the digital model represented by the facet into a signed distance field and introduce a simulated physical field of the forming/service simulation, the feature distance field after the frequency domain analysis filtering, and the geometric feature field obtained by the multi-precision convolution unit analysis according to the requirement of feature to be identified, then, multiple fields are combined to realize feature classification determination and labeling of features, and finally feature extraction is completed based on field data and isosurface and isoline reconstruction algorithms.

### CROSS-REFERENCE TO RELATED APPLICATION

This application claims the priority benefit of China application serial no. 202310959914.X, filed on Aug. 1, 2023. The entirety of the above-mentioned patent application is hereby incorporated by reference herein and made a part of this specification.

### BACKGROUND

### Technical Field

The disclosure belongs to the technical field related to additive manufacturing model preprocessing, and more particularly relates to a field-based additive manufacturing digital model feature identification and extraction method and device.

### Description of Related Art

With the rapid development of additive manufacturing technology, the application thereof in industrial production such as aerospace, auxiliary medical care, transportation is becoming more and more extensive. The components required in these fields usually have complex structures and need to be compatible with multiple functions, such as ultra-lightweight, ultra-high load-bearing capacity, extreme heat resistance, and high reliability. These functions often have regional differences due to the different environments faced by different parts when the components are in service, which means that for the same component, in different areas, different materials need to be used and different process parameters need to be adopted to match functional difference requirements. At the same time, adjusting process parameters according to individual geometric features within complex models can effectively improve manufacturing speed and printing quality. Therefore, in the preprocessing of additive manufacturing digital models, it is of great significance to identify and extract the geometric and process features of the model in order to assign different processing parameters. However, the data files processed and transmitted in the existing CAD/CAM links (such as STL files, and slice contour data) usually only contain surface information, and the feature identification and extraction methods developed using these files are generally based on contour shapes, topological shapes, or visual shapes, which have problems of few identifiable features, difficulty extraction, and low efficiency. Therefore, how to easily and efficiently identify the geometric features and process features of additive manufacturing digital models and extract these features for additive manufacturing data processing is an urgent problem to be solved.

In order to solve the problem of feature identification and extraction of additive manufacturing digital models, researchers in this field have proposed some solutions, for example, Arthur Hilbig of the Technical University of Dresden proposed a feature identification method based on a three-dimensional convolutional neural network, which uses signed distance field data to limit the resolution of required voxels and improve identification precision. This method considers the possibility of feature identification in detail by evaluating different 3D-CNN network structures, but the method still marks the surface information of the B-Rep (boundary representation) model and cannot identify more specific geometric features such as thin walls. Panagiotis Stavropoulos from the University of Patras proposed a method that can embed AM-related knowledge and identify features relevant to AM manufacturability from a global CAD model, which mainly targets STP format files and identifies features such as thin walls, overhangs, minimum detail sizes, and unsupported structures through the decomposition and reconstruction of geometric information. This method is still based on conventional contour feature identification and cannot identify internal information of the model. Patent CN115592287A discloses “Additive and Subtractive Manufacturing Method for Pore and Narrow Gap Features”, CN115647386A discloses “Additive and Subtractive Manufacturing Method for Sharp Corner Features”, and the literature all convert three-dimensional models into two-dimensional slices and then perform 2D contour feature identification based on specific feature attributes, and the scope of application is relatively concentrated. In addition, people outside the field have also proposed some feature identification methods. Patent CN114820524A discloses “3D feature identification method for Alzheimer disease in MRI image”, which uses a convolutional neural network to extract and identify features from a series of MRI two-dimensional images, and the method combines local features and global features and is a processing method based on image feature identification. Patent CN106599515A discloses “Automobile Covering Part Sheet Metal Forming Technology Optimizing Method Based on STL Grid Feature Identification” which also discloses a part feature tree construction method based on contour features and topological features, structural feature identification is mainly completed through the adjacency relationship of the boundary triangle mesh and the Gaussian curvature and mean curvature of the surface, and relatively few features can be identified. Accordingly, there is an urgent need in this field to develop an efficient and universal method for geometric and process feature identification and extraction suitable for current additive manufacturing digital model preprocessing.

### SUMMARY

In view of the above defects or improvement needs of the related art, the disclosure provides a field-based additive manufacturing digital model feature identification and extraction method and device, the method can convert the digital model represented by the facet into a signed distance field and introduce a simulated physical field of the forming/service simulation, the feature distance field after the frequency domain analysis filtering, and the geometric feature field obtained by the multi-precision convolution unit analysis according to the requirement of feature to be identified, then, multiple fields are combined to realize classification determination and labeling of features, and finally feature extraction is completed based on field data and isosurface and isoline reconstruction algorithms. This method can flexibly and efficiently identify various process and geometric features of complex additive manufacturing digital models. At the same time, compared with conventional feature identification methods based on contour, topology, and vision, this method can extensively extract internal features of the model.

To achieve the above purpose, according to an aspect of the disclosure, a field-based additive manufacturing digital model feature identification and extraction method is provided, and the method includes steps as follows.

Step 1: The signed distance field conversion is performed on a 3D digital model of a component to be additively manufactured to obtain implicit distance field data.

Step 2: Whether there is a requirement for identifying functional difference features is determined. If yes, then forming/service simulation analysis is performed according to the functional requirement of the 3D model, and the simulation result obtained is converted into simulated physical field data; if no, then the operation proceeds directly to Step 3.

Step 3: Whether it is necessary to identify periodic features is determined. If yes, then three-dimensional frequency domain conversion is performed on the distance field data to obtain frequency domain data, a bandpass filter, a bandstop filter, a high-pass filter, and a low-pass filter are designed based on the frequency domain data, the filters obtained are adopted to perform filtering processing on the frequency domain data, and three-dimensional inverse frequency domain conversion is performed on the frequency domain data filtered to obtain feature distance field data; if no, then the operation proceeds directly to Step 4.

Step 4: A series of convolution unit precisions is set according to the estimated size of a geometric feature to be identified.

Step 5: Data analysis of a distance field and a gradient vector field obtained by derivation of the distance field is completed in each convolution unit.

Step 6: Statistical data of the convolution units of different precisions and neighboring convolution units are combined to label feature attributes of spatial points to obtain a geometric feature field.

Step 7: The distance field data, the simulated physical field data, the feature distance field data, and the geometric feature field are combined to perform classification determination and labeling of features.

Step 8: Identification of the 3D model of geometric and process features, 3D feature extraction, and 2D feature extraction are performed respectively through volume rendering, isosurface reconstruction algorithm, and isoline reconstruction algorithm based on the feature labeling field obtained in Step 7.

Furthermore, the method for distance field conversion includes a signed distance field, a precise Euclidean distance field, a rough distance field, and an adaptively sampled distance field.

Furthermore, the 3D digital model is converted into the distance field data so that each spatial point may return the shortest signed distance SDF (x, y, z) from the point to a model boundary.

Furthermore, the simulation result is converted into the simulated physical field by an interpolation calculation method. Forming/service simulation is determined by functional area differences to be identified, including temperature data, stress data, deformation data for forming process simulation, and stress-strain data and heat transfer data for service process simulation.

Furthermore, the simulated physical field data converted enables each spatial point to return simulated physical information SPF (x, y, z) of the point, and SPF (x, y, z) is calculated to obtain the temperature value of any point in the model after simulated forming.

Furthermore, an object of three-dimensional frequency domain conversion is the signed distance field data SDF (x, y, z) of the model, and a conversion method comprises Fourier transform, Laplace transform, and Z transform.

Furthermore, SDF (x, y, z) is converted into F (u, v, w), that is, superposition data of sine waves in three directions, by three-dimensional discrete Fourier transform (DFT) and fast Fourier transform (FTT), frequency domain information in the three directions are sampled and converted into a three-dimensional visualized spectrogram, and the spectrogram comprises a frequency f, an amplitude A, a direction n, and a phase Φ.

Furthermore, filtering processing is to calculate a dot product of a specific filter and the frequency domain data, that is H (u, v, w)·F(u, v, w), and then three-dimensional inverse frequency domain conversion is performed on a spectrogram filtered to obtain the series of feature distance field data extracted based on frequency domain features so that for each of the spatial points in a feature retained by the filter, a signed distance FSDF (x, y, z) from the point to a model boundary is returned.

The disclosure further provides a field-based additive manufacturing digital model feature identification and extraction system, the system includes a storage and a processor, the storage stores a computer program, and when the processor executes the computer program, the field-based additive manufacturing digital model feature identification and extraction method as described above is performed.

The disclosure further provides a computer-readable storage medium, the computer-readable storage medium stores machine-executable commands, and when the machine-executable commands are called and executed by a processor, the machine-executable commands may cause the processor to implement the field-based additive manufacturing digital model feature identification and extraction method as described above.

In summary, compared with the related art, the field-based additive manufacturing digital model feature identification and extraction method and device provided by the disclosure mainly have the beneficial effects as follows.

1. The disclosure converts the facet model only expressing boundary information into signed distance field data, and at the same time, the simulated physical field, frequency domain feature distance field, and geometric feature field are combined according to identification requirements to perform feature identification and extraction, which can describe internal information of the model that cannot be expressed by conventional methods. It can be compatible with process features and geometric feature recognition that have functional differences and geometric differences and is universal and efficient.

2. The disclosure provides a frequency domain identification method for periodic features. To solve the problem that it is difficult for conventional feature identification methods based on contour, topology, and visual shape to extract lattice, the method uses three-dimensional frequency domain conversion of the signed distance field information to perform data analysis and designs a reasonable filter based on frequency and amplitude distribution. In this way, the periodic features can be quickly identified, and finally, the periodic distance field is obtained through three-dimensional inverse frequency domain conversion.

3. The disclosure also considers the analysis of distance field information based on convolution units of different precisions to identify geometric features. The geometric feature attributes of spatial points such as whether the attributes are thin walls, sharp corners, lattices, and blocks are determined through information such as the distance field mean, extreme value, porosity, gradient field in a single convolution unit, and the information recorded by neighboring units and higher-precision units, and the method is simple and efficient.

4. The disclosure combines multiple field data including, for example, distance field, simulated physical field, feature distance field, and geometric feature field to label and divide the space, and finally, feature extraction is completed through surface reconstruction algorithms and isoline reconstruction algorithms. Compared with conventional feature extraction algorithms based on facets and contours, the disclosure does not require facet or contour clipping operations and is simpler. In summary, the field-based additive manufacturing digital model feature identification and extraction method proposed in the disclosure fully considers the feature types that need to be extracted in the feature identification of the additive manufacturing model preprocessing field, and provides a simple and efficient model boundary and internal feature labeling and extraction method, at the same time, the disclosure is compatible with the process features and geometric features meeting the requirements of additive manufacturing, thereby the problems of few identifiable features of the model, difficult extraction, and low efficiency are effectively solved.

### BRIEF DESCRIPTION OF THE DRAWINGS

FIG. 1 is a flow chart of a field-based additive manufacturing digital model feature identification and extraction method according to an embodiment of the disclosure.

FIG. 2 is a schematic diagram of a facet model implemented according to the method of the disclosure.

FIG. 3 is a schematic diagram of converting the facet model into a signed distance field according to the method of the disclosure.

FIG. 4 is a schematic diagram of the temperature field obtained by simulating the model forming process implemented according to the method of the disclosure.

FIG. 5 is a schematic diagram of frequency domain data after three-dimensional frequency domain conversion of a distance field implemented according to the method of the disclosure.

In FIG. 6, (a), (b), (c), and (d) are respectively schematic diagrams of a low-pass filter, a high-pass filter, a bandstop filter, and a bandpass filter implemented according to the method of the disclosure.

FIG. 7 is a schematic diagram of convolution units of different precisions implemented according to the method of the disclosure.

FIG. 8 is a schematic diagram of converting a distance field into a gradient vector field according to the method of the disclosure.

FIG. 9 is a schematic diagram of information contained in a convolution unit of a model thin-wall feature distance field (presented in a 2D slice for convenience of display).

FIG. 10 is a schematic diagram of information contained in a convolution unit of a model sharp corner feature distance field (presented in a 2D slice for convenience of display).

FIG. 11 is a schematic diagram of information contained in a convolution unit of a model lattice feature distance field (presented in a 2D slice for convenience of display).

In FIG. 12, (a) and (b) are respectively schematic diagrams of two sub-models after model feature extraction.

### DESCRIPTION OF THE EMBODIMENTS

In order to make the purpose, technical solutions, and advantages of the disclosure more clearly understood, the disclosure is further described in detail below together with the accompanying drawings and embodiments. It should be understood that the specific embodiments described herein are only used to explain the disclosure, and the embodiments are not used to limit the disclosure. In addition, the technical features involved in the various embodiments of the disclosure described below may be combined with each other as long as the features do not conflict with each other.

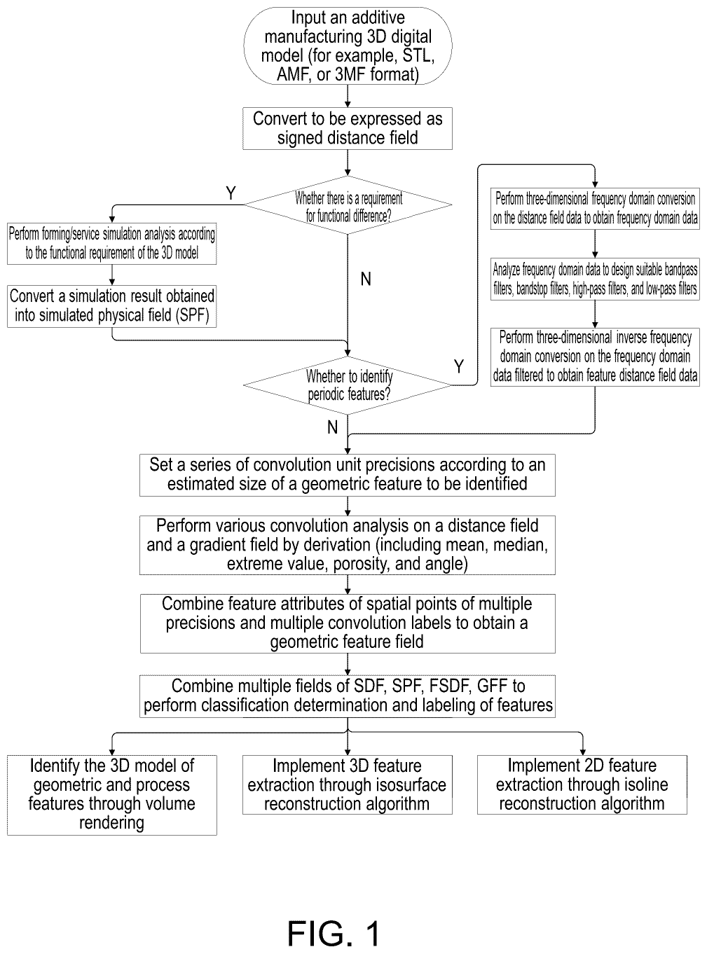

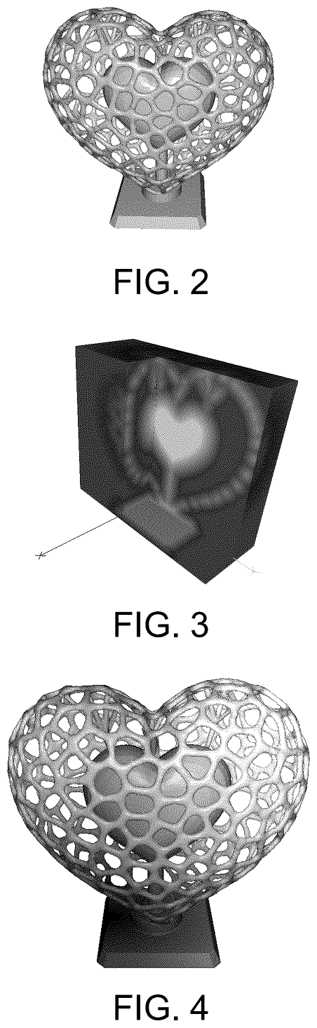

Please refer to FIG. 1 and FIG. 2, the disclosure provides a field-based additive manufacturing digital model feature identification and extraction method, and the method mainly includes steps as follows.

Step 1: The signed distance field conversion is performed on a 3D digital model of a component to be additively manufactured to obtain implicit distance field data.

In the operation, the 3D digital model of the component to be additively manufactured is obtained, and a commonly used STL file in the field of additive manufacturing is taken as an example. As shown in FIG. 2, a complex geometric model including lattices, thin walls, and blocks is input. Signed distance field conversion is performed on the 3D model to obtain the implicit distance field data (SDF). As shown in FIG. 3, by converting triangular mesh data into distance field data, SDF (x, y, z) is calculated to obtain the shortest signed distance from each point in space to the original model boundary.

In this embodiment, the method for distance field conversion includes a signed distance field, a precise Euclidean distance field, a rough distance field, and an adaptively sampled distance field. An appropriate distance field method is selected based on the required model geometric feature identification precision and conversion efficiency, the additive manufacturing 3D digital model is converted into the distance field data so that each spatial point may return the shortest signed distance SDF (x, y, z) from the point to a model boundary.

Step 2: Whether there is a requirement for identifying functional difference features is determined. If yes, then forming/service simulation analysis is performed according to the functional requirement of the 3D model, and the simulation result obtained is converted into simulated physical field data; if no, then the operation proceeds directly to Step 3.

Forming/service simulation is determined by functional area differences to be identified, including temperature data, stress data, deformation data for forming process simulation, and stress-strain data and heat transfer data for service process simulation. The data may be used to guide and identify corresponding process feature areas such as temperature accumulation area, residual stress concentration area, large deformation area, stress concentration area, and poor heat transfer area.

The simulation result is converted into the simulated physical field by an interpolation calculation method. Specifically, forming/service simulation often includes, for example, finite element method (FEM) and finite cell method (FCM), and the basic data units thereof generally include, for example, tetrahedron, hexahedron, and voxel units. The interpolation methods based on these units include, for example, tetrahedral interpolation, hexahedral interpolation, voxel interpolation, and nearest neighbor interpolation. Users may select an appropriate interpolation method based on the unit type and the calculation efficiency. The simulated physical field data converted enables each spatial point to return simulated physical information SPF (x, y, z) of the point, which refers to, for example, stress, strain, temperature, and deformation.

In this embodiment, the forming/service simulation analysis is completed based on the 3D model according to the functional requirements of the model. For the model input, it is necessary to determine which areas have severe heat intensity in order to adjust the process parameters. Therefore, the forming process of the model is simulated to obtain temperature distribution data, as shown in FIG. 4. The temperature distribution data obtained from the forming simulation is converted into the simulated physical field data (SPF) through the tetrahedral interpolation. SPF (x, y, z) is calculated to obtain the temperature value of any point in the model after simulated forming, so that the value may be used in subsequent steps.

Step 3: Whether it is necessary to identify periodic features is determined. If yes, then three-dimensional frequency domain conversion is performed on the distance field data to obtain frequency domain data, a bandpass filter, a bandstop filter, a high-pass filter, and a low-pass filter are designed based on the frequency domain data, the filters obtained are adopted to perform filtering processing on the frequency domain data, and three-dimensional inverse frequency domain conversion is performed on the frequency domain data filtered to obtain feature distance field data; if no, then the operation proceeds directly to Step 4.

An object of three-dimensional frequency domain conversion is the signed distance field data SDF (x, y, z) of the model. The conversion method mainly includes the Fourier transform, Laplace transform, and Z transform, in which the most commonly used Fourier transform decomposes the 3D signed distance field data into a combination of a series of three-dimensional sine waves. The conversion formula is as follows: F[SDF(x, y, z)]=∫∫∫SDF(x, y, z)e^{-i(xw}^{₁}^{+yw}^{₂}^{+Zw}^{₃}⁾dxdydz.

The discrete form thereof is:

$$F ( u , v , w ) = {\sum }_{0}^{N - 1} {\sum }_{0}^{N - 1} {\sum }_{0}^{N - 1} S D F ( x , y , z ) {e}^{- i 2 π ( \frac{u x}{N} + \frac{vy}{N} + \frac{w z}{N} )} .$$

Based on the above, SDF (x, y, z) may be converted into F(u, v, w), that is, superposition data of sine waves in three directions, by three-dimensional discrete Fourier transform (DFT) and fast Fourier transform (FTT). Frequency domain information in the three directions may be sampled and converted into a three-dimensional visualized spectrogram, and the spectrogram includes a frequency f, an amplitude A, a direction n, and a phase Φ for subsequent use; in the formula, N is the number of samples in the X, Y, and Z directions, and i is the imaginary unit; u, v, and w are the three frequency domain variables after conversion.

Frequency domain data analysis is to obtain statistics on frequency domain band data with larger amplitude based on the obtained spectrograms in the three directions. The data is the main component signals of the periodic structure. Reasonable low-pass, high-pass, bandpass, and bandstop filters are designed according to feature identification requirements to filter and extract frequency domain features. Specifically, the low-pass filter only retains signals with lower frequencies, the high-pass filter only retains signals with higher frequencies, the bandpass filter only retains signals within a specific frequency band, the bandstop filter only retains signals outside a specific frequency band, and the definitions thereof are as follows:

$$Low - pass : H ( u , v , w ) = \{ \begin{matrix}1 & if D ( u , v , w ) \leq {D}_{0} \\ 0 & if D ( u , v , w ) < {D}_{0}\end{matrix} ,$$

$$High - pass : H ( u , v , w ) = \{ \begin{matrix}0 & if D ( u , v , w ) \leq {D}_{0} \\ 1 & if D ( u , v , w ) < {D}_{0}\end{matrix} ,$$

$$Bandpass : H ( u , v , w ) = \{ \begin{matrix}0 & if D ( u , v , w ) < {D}_{0} - \frac{d}{2} \\ 1 & if {D}_{0} + \frac{d}{2} \leq D ( u , v , w ) \leq {D}_{0} - \frac{d}{2} \\ 0 & if D ( u , v , w ) > {D}_{0} + \frac{d}{2}\end{matrix} ,$$

$$Bandstop : H ( u , v , w ) = \{ \begin{matrix}1 & if D ( u , v , w ) < {D}_{0} - \frac{d}{2} \\ 0 & if {D}_{0} + \frac{d}{2} \leq D ( u , v , w ) \leq {D}_{0} - \frac{d}{2} \\ 1 & if D ( u , v , w ) > {D}_{0} + \frac{d}{2}\end{matrix} .$$

In the formula, D(u, v, w) is the value of the frequency f in the position (u, v, w) of the spectrogram, D₀ is the user-selectable filter specific frequency value, and

$$\frac{d}{2}$$

is the user-selectable filter radius.

Filtering processing is to calculate a dot product of a specific filter and the frequency domain data, that is H (u, v, w)·F (u, v, w), and then three-dimensional inverse frequency domain conversion is performed on the filtered spectrum to obtain a series of feature distance field data extracted based on frequency domain features, so that for each spatial point in a feature retained by the filter, the signed distance FSDF (x, y, z) from the point to the model boundary may be returned to guide subsequent feature identification. Specifically, the commonly used three-dimensional inverse Fourier transform formula is as follows, based on which the conversion may be completed through the three-dimensional inverse discrete Fourier transform (IDFT) and inverse fast Fourier transform (IFTT):

$$FSDF ( x , y , z ) = \frac{1}{N * N * N} {\sum }_{0}^{N - 1} {\sum }_{0}^{N - 1} {\sum }_{0}^{N - 1} H ( u , v , w ) \cdot F ( u , v , w ) {e}^{i 2 π ( \frac{u x}{N} + \frac{vy}{N} + \frac{w z}{N} )}$$

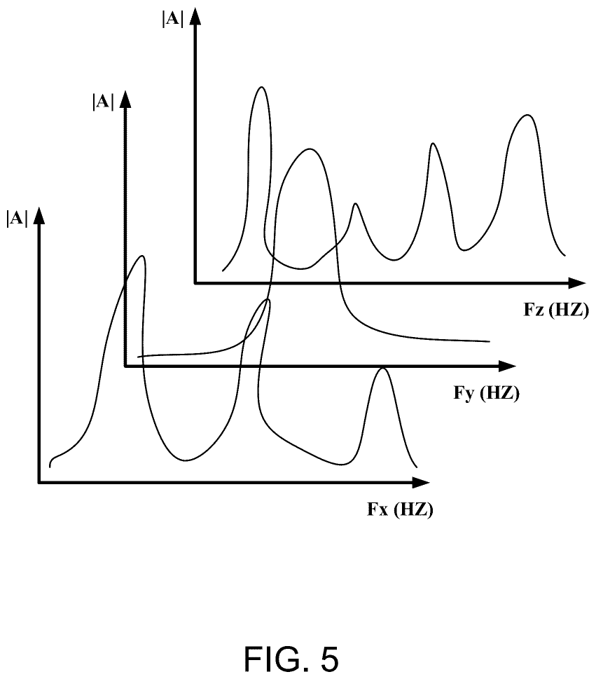

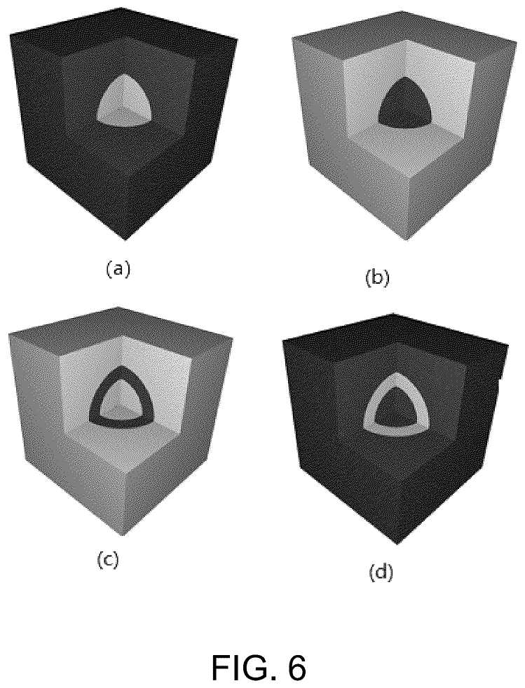

In this embodiment, according to the identification of periodic lattice features, three-dimensional frequency domain conversion is performed on the model distance field to obtain corresponding frequency domain data thereof. Considering the discrete feature and efficiency of the computer, the fast Fourier transform (FTT) in the frequency domain conversion method is used to calculate the frequency domain information of the distance field. The 3D spectrum data obtained is analyzed (as shown in FIG. 5), and reasonable bandpass, bandstop, high-pass, and low-pass filters are designed according to distribution information of data such as frequency and amplitude (as shown in FIG. 6). The spectrum data of the model is analyzed, and the distribution information of data such as frequency and amplitude in the three directions are obtained, in which the signals in the frequency range with higher amplitudes make a greater contribution to the periodic geometric features. Therefore, the frequency domain features may be extracted by designing the bandpass filters to be near the frequencies. After the original frequency domain data is filtered by multiple bandpass filters near different frequencies, a three-dimensional inverse fast Fourier transform (IFTT) is performed to obtain feature distance field data (FSDF) with different frequency distributions, and different FSDF (x, y, z) is calculated to obtain the signed distance value from each spatial point in the feature retained by the filter to the model boundary, so that the value may be used in subsequent steps.

Step 4: A series of convolution unit precisions is set according to the estimated size of a geometric feature to be identified.

The estimated size of the geometric feature is defined according to the requirements. For example, a geometric feature with a thickness less than H₀ may be defined as a thin wall. Then, a series of convolution unit precisions including H₀/5, H₀/2, H₀, 2H₀, and 5H₀ may be set according to the value to fully record the distance field information of the geometric feature. For geometric features of different sizes, the smallest feature value is selected as H₀.

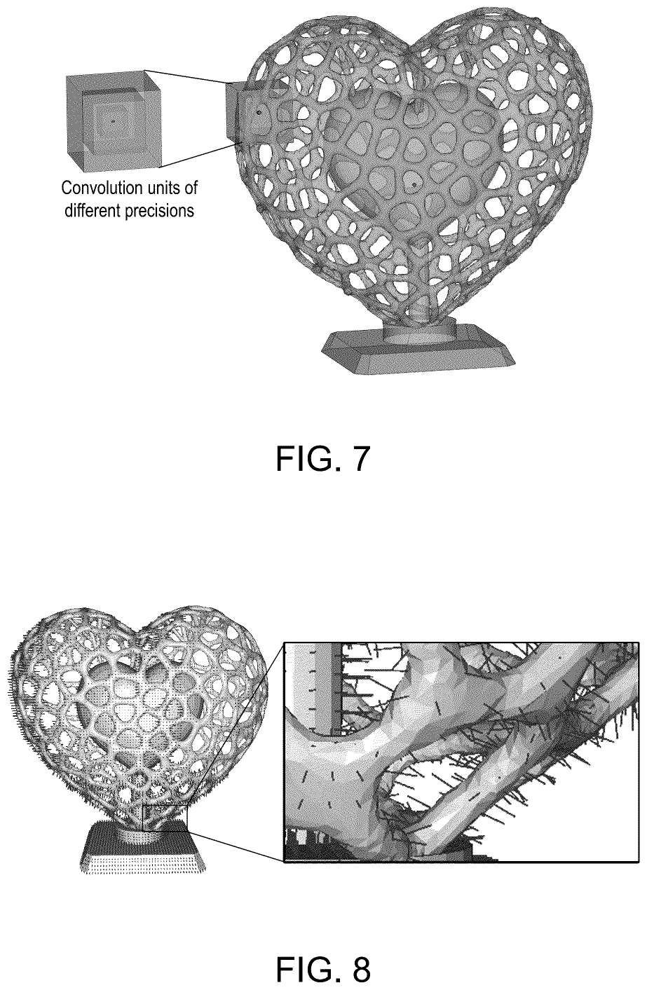

In this embodiment, a series of convolution unit precisions are set according to the estimated size of the geometric feature to be identified; in this example, the minimum feature size defined by the user is 5 mm, and based on this value, a series of convolution unit precisions including 1 mm, 2.5 mm, 5 mm, 10 mm, and 25 mm are set to fully record the distance field information of the geometric feature. Examples of convolution units with different precisions are shown in FIG. 7.

Step 5: Data analysis of a distance field and a gradient vector field obtained by derivation of the distance field is completed in each convolution unit.

The solution formula for the gradient field is as follows:

$$Grad ( x , y , z ) = ∇ S D F ( x , y , z ) = \frac{\partial S D f}{\partial x} i + \frac{\partial S D f}{\partial y} j + \frac{\partial S D f}{\partial z} k ;$$

the central difference form is:

$$\frac{\partial S D f}{\partial x} = \frac{S D F ( x + Δ {X}_{0} , y , z ) - S D F ( x - Δ {X}_{0} , y , z )}{2 Δ {X}_{0}} ,$$

$$\frac{\partial S D f}{\partial y} = \frac{S D F ( x , y + Δ {Y}_{0} , z ) - S D F ( x , y - Δ {Y}_{0} , z )}{2 Δ {Y}_{0}} ,$$

$$\frac{\partial S D f}{\partial z} = \frac{S D F ( x , y , z + Δ {Z}_{0} ) - S D F ( x , y , z - Δ {Z}_{0} )}{2 Δ {Z}_{0}} .$$

Specifically, for the gradient vector value in the convolution unit, the angle between each vector and the forming Z direction may be calculated for subsequent determination of the overhang area. For the distance field value in the convolution unit, first, whether the area is located at the boundary or inside the entity is determined according to the distance field sign; in addition, the mean and median may be calculated to determine the approximate position from the convolution unit to the boundary. Also, whether there is an extreme value occurring in the unit may be analyzed. If the extreme value occurs and the unit is located at the boundary, then the feature may be considered as a thin wall or a sharp corner. At the same time, the porosity within the unit may be calculated so as to determine whether the feature may be a lattice feature.

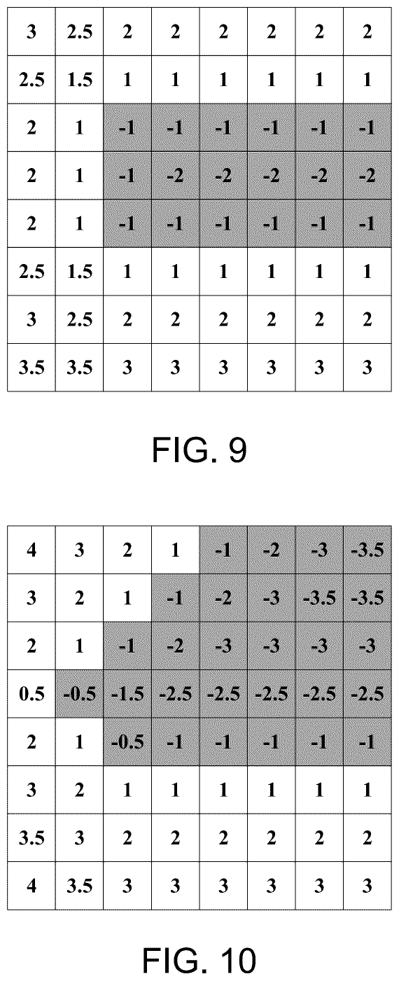

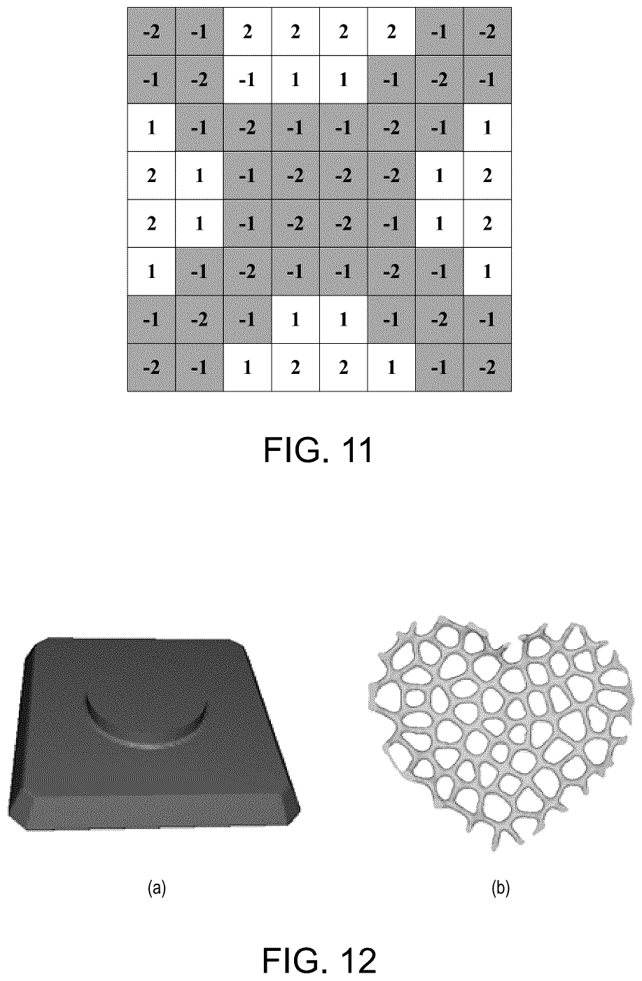

In this implementation, data analysis of the distance field and the gradient vector field obtained by derivation of the distance field is completed in each convolution unit, including, for example, mean, median, extreme value, porosity, and angle of the gradient vector. The gradient vector field of the distance field of the model is calculated by central difference (as shown in FIG. 8), and the numerical value of the distance from each point to the gradient and the angle with the forming Z direction may be obtained. Generally, spatial points near the model surface and with an angle greater than 45 degrees belong to the overhang area. For the distance field value in the convolution unit, first, whether the area is located at the boundary or inside the entity is determined according to the distance field sign; in addition, the mean and median may be calculated to determine the approximate position from the convolution unit from the boundary. Also, whether there is an extreme value occurring in the unit may be analyzed. If the extreme value occurs and the unit is located at the boundary, then the feature may be considered as a thin wall (as shown in FIG. 9) or a sharp corner (as shown in FIG. 10). At the same time, the porosity within the unit may be calculated so as to determine whether the feature may be a lattice feature (as shown in FIG. 11).

Step 6: Statistical data of the convolution units of different precisions and neighboring convolution units are combined to label feature attributes of spatial points to obtain a geometric feature field.

Multiple convolution units of different precisions belonging to the current space and neighboring convolution units thereof are used to determine the feature attributes of a certain spatial position. Since both the distance field and the gradient field are continuous, the geometric feature may be further identified and determined according to the data information calculated in the previous operation together with the data information of the adjacent units, and the space within the convolution unit range are labeled to obtain the geometric feature field data, so that for each spatial point, the geometric feature type GFF (x, y, z) to which the point belongs may be returned. For example, a feature value 0 is labeled as a general area, a feature value 1 is labeled as a thin-walled area, a feature value 2 is labeled as an overhang area, a feature value 3 is labeled as a sharp corner area, a feature value 4 is labeled as a lattice area, and other features may be customized and extended by the user.

In this embodiment, statistical data of the convolution units of different precisions and neighboring convolution units are used to label the feature attributes of the spatial points to obtain the geometric feature field (GFF). Since a single convolution unit most likely contains only partial information about the geometric feature, and the distance field and the gradient field are continuous, therefore, the geometric feature may be further identified and determined according to the data information calculated in the previous operation together with the data information of the adjacent units, and the space within the convolution unit range are labeled to obtain the geometric feature field data, so that for each spatial point, the geometric feature type GFF (x, y, z) to which the point belongs may be returned. If the feature value 0 is returned, then the area is labeled as the general area, the feature value 1 is labeled as the thin-walled area, the feature value 2 is labeled as the overhang area, the feature value 3 is labeled as the sharp corner area, and the feature value 4 is labeled as the lattice area.

Step 7: The distance field data, the simulated physical field data, the feature distance field data, and the geometric feature field are combined to perform classification determination and labeling of features.

The joint determination may be performed by adopting field-based implicit Boolean operations and other logical operations. For example, the lattice labeling field of a specific period may be identified by the implicit Boolean intersection operation of the distance field SDF and the feature distance field FSDF, and the specific operation is max (SDF(x, y, z), FSDF(x, y, z)). Also, the feature belonging to both the thin-walled area and the large deformation area may also be identified and labeled by AND operation, the specific operation is GFF (x, y, z)==1 && SPF (x, y, z)>Def₀, and Def₀ is a deformation threshold value set the user. In short, combining multiple fields according to needs can achieve classification determination and labeling of features.

In this implementation, multiple fields including SDF, SPF, FSDF, and GFF are combined to implement classification determination and labeling of features, and multiple feature labeling fields are obtained for subsequent rendering and feature extraction. In this example, the lattice labeling field of a specific period is identified by the implicit Boolean intersection operation max (SDF(x, y, z), FSDF(x, y, z)) of the distance field SDF and the feature distance field FSDF. At the same time, the labeling field belonging to both the thin-walled area and the heat accumulated area may also be identified by logical AND operation GFF (x, y, z)==1 && SPF (x, y, z)>T₀ (T₀ is a temperature threshold value set the user).

Step 8: Identification of the 3D model of geometric and process features, 3D feature extraction, and 2D feature extraction are performed respectively through volume rendering, isosurface reconstruction algorithm, and isoline reconstruction algorithm based on the feature labeling field obtained in Step 7.

Volume rendering algorithms include ray tracing algorithm, ray casting algorithm, and frequency domain algorithm, the surface reconstruction algorithms include, for example, the marching cubes (MC) algorithm, dual contouring (DC) algorithm, and simple marching cubes (SMC) algorithm, the isoline reconstruction algorithms include marching squares (MS) algorithm and simple marching squares (SMS) algorithm.

In this embodiment, based on the feature labeling field, algorithms such as volume rendering, isosurface reconstruction, and isoline reconstruction are used according to needs to complete model rendering, 3D feature extraction, and 2D feature extraction. This example is based on the need to reconstruct sub-models of data of two labeling fields identified in the previous operation through the MC algorithm (as shown in FIG. 12), so as to allocate appropriate process parameters to achieve functional difference and improve printing quality.

The disclosure further provides a field-based additive manufacturing digital model feature identification and extraction system, the system includes a storage and a processor, the storage stores a computer program, and when the processor executes the computer program, the field-based additive manufacturing digital model feature identification and extraction method as described above is performed.

The disclosure further provides a computer-readable storage medium, the computer-readable storage medium stores machine-executable commands, and when the machine-executable commands are called and executed by a processor, the machine-executable commands may cause the processor to implement the field-based additive manufacturing digital model feature identification and extraction method as described above.

It is easily understood by persons skilled in the art that the above description includes only preferred embodiments of the disclosure and the embodiments are not intended to limit the disclosure. Any modifications, equivalent substitutions, and improvements made within the spirit and principles of the disclosure should be included in the protection scope of the disclosure.

What is claimed is:

1. A field-based additive manufacturing digital model feature identification and extraction method, wherein the method comprises steps as follows:
step 1: performing signed distance field conversion on a 3D digital model of a component to be additively manufactured to obtain implicit distance field data;
step 2: determining whether there is a requirement for identifying functional difference features; if yes, then performing forming/service simulation analysis according to the functional requirement of the 3D model, and converting a simulation result obtained into simulated physical field data; if no, then proceeding directly to step 3;
step 3: determining whether necessary to identify periodic features; if yes, then performing three-dimensional frequency domain conversion on the distance field data to obtain frequency domain data, designing a bandpass filter, a bandstop filter, a high-pass filter, and a low-pass filter based on the frequency domain data, adopting the filters obtained to perform filtering processing on the frequency domain data, and performing three-dimensional inverse frequency domain conversion on the frequency domain data filtered to obtain feature distance field data; if no, then proceeding directly to step 4;
step 4: setting a series of convolution unit precisions according to an estimated size of a geometric feature to be identified;
step 5: completing data analysis of a distance field and a gradient vector field obtained by derivation of the distance field in each convolution unit;
step 6: combining statistical data of the convolution units of the respective precisions and neighboring convolution units to label feature attributes of spatial points to obtain a geometric feature field;
step 7: combining the distance field data, the simulated physical field data, the feature distance field data, and the geometric feature field to perform classification determination and labeling of features;
step 8: performing identification of the 3D model of geometric features and process features, 3D feature extraction, and 2D feature extraction respectively through volume rendering, isosurface reconstruction algorithm, and isoline reconstruction algorithm based on the feature labeling field obtained in step 7.

2. The field-based additive manufacturing digital model feature identification and extraction method as claimed in claim 1, wherein a method for distance field conversion comprises a signed distance field, a precise Euclidean distance field, a rough distance field, and an adaptively sampled distance field.

3. The field-based additive manufacturing digital model feature identification and extraction method as claimed in claim 1, wherein the 3D digital model is converted into the distance field data so that each of the spatial points returns the shortest signed distance SDF (x, y, z) from the point to a model boundary.

4. The field-based additive manufacturing digital model feature identification and extraction method as claimed in claim 1, wherein the simulation result is converted into the simulated physical field by an interpolation calculation method; forming/service simulation is determined by functional area differences to be identified, comprising temperature data, stress data, deformation data for forming process simulation, and stress-strain data and heat transfer data for service process simulation.

5. The field-based additive manufacturing digital model feature identification and extraction method as claimed in claim 1, wherein the simulated physical field data converted enables each of the spatial points to return simulated physical information SPF (x, y, z) of the point, and SPF (x, y, z) is calculated to obtain a temperature value of any point in the model after simulated forming.

6. The field-based additive manufacturing digital model feature identification and extraction method as claimed in claim 1, wherein an object of three-dimensional frequency domain conversion is the signed distance field data SDF (x, y, z) of the model, and a conversion method comprises Fourier transform, Laplace transform, and Z transform.

7. The field-based additive manufacturing digital model feature identification and extraction method as claimed in claim 6, wherein the SDF (x, y, z) is converted into F (u, v, w), that is, superposition data of sine waves in three directions, by three-dimensional discrete Fourier transform and fast Fourier transform, frequency domain information in the three directions are sampled and converted into a three-dimensional visualized spectrogram, and the spectrogram comprises a frequency f, an amplitude A, a direction n, and a phase Φ.

8. The field-based additive manufacturing digital model feature identification and extraction method as claimed in claim 1, wherein the filtering processing is to calculate a dot product of a specific filter and the frequency domain data, that is H (u, v, w)·F (u, v, w), and then three-dimensional inverse frequency domain conversion is performed on a spectrogram filtered to obtain a series of the feature distance field data extracted based on frequency domain features, so that for each of the spatial points in a feature retained by the filter, a signed distance FSDF (x, y, z) from the point to a model boundary is returned.

9. A field-based additive manufacturing digital model feature identification and extraction system, wherein the system comprises a storage and a processor, the storage stores a computer program, and in response to the processor executing the computer program, the field-based additive manufacturing digital model feature identification and extraction method as claimed in claim 1 is performed.

10. A computer-readable storage medium, wherein the computer-readable storage medium stores machine-executable commands, and in response to the machine-executable commands are called and executed by a processor, the machine-executable commands cause the processor to implement the field-based additive manufacturing digital model feature identification and extraction method as claimed in claim 1.
